(19) United States
(12) Patent Application Publication
(10) Pub. No.: US 2002/0045268 A1
(43) Pub. Date: Apr. 18, 2002

(54) MEASURING ANALYTES WITH METAL-LIGAND COMPLEX PROBES

(76) Inventors: JOSEPH R. LAKOWICZ, ELLICOTT CITY, MD (US); HENRYK SZMACINSKI, CARMEL, IN (US); EWALD TERPETSCHNIG, REGENSBURG (DE); ZAKIR MURTAZA, INDIANAPOLIS, IN (US)

Correspondence Address: GEORGE R REPPER, ROTHWELL FIGG ERNST & KURZ, SUITE 701-EAST, 555 13TH STREET N W, WASHINGTON, DC, 20004

(21) Appl. No.: 09/226,715

(22) Filed: Jan. 7, 1999

Related U.S. Application Data
(63) Continuation-in-part of application No. 08/808,563, filed on Feb. 28, 1997, now abandoned.

(51) Int. Cl. G01N 31/22

(52) U.S. Cl. 436/164

(57) ABSTRACT

In accordance with the present invention, a method of measuring an analyte in a sample includes the following steps. A metal-ligand complex probe is contacted with a sample containing analyte. The probe is bound to analyte in the sample to form an analyte-bound probe species. Both bound and unbound species of the probe exist in the sample. At least one of the bound and unbound species is fluorescent, with each of the bound and unbound species being optically distinguishable. The sample containing the bound and unbound species is excited with radiation, so as to produce a resulting emission from at least one of the bound and unbound species. The resulting emission is detected, so as to provide an optical measurement of the emission. Concentration of analyte in the sample is determined utilizing the optical measurement of the emission.

### BACKGROUND OF THE INVENTION

This work was supported by the National Institutes of Health and the National Science Foundation.

### FIELD OF THE INVENTION

The present invention relates to the field of measuring analytes in a sample.

### DESCRIPTION OF THE BACKGROUND ART

Measurement of certain analytes in blood, such as pH and carbon dioxide, is an important aspect of the clinical care of patients. Previously, such measurements have been made using gas chromatography and other chemical methods. These methods are disadvantageous in that it is necessary to ship the blood sample to a clinical laboratory for analysis, which often results in a delay of an hour or more. Moreover, since the blood gases change rapidly, the shipping time may cause the results to be invalid. Furthermore, these known methods cannot be used for continuous in vivo monitoring of blood.

Optical methods for measurement of blood chemistry, such as fluorescence-based methods, are of great interest because they offer the possibility of decreased cost and less handling of possibly contaminated blood.

During the past several years there has been increasing interest in fluorescence lifetime-based sensing. In this method the analyte concentration is determined from the decay time of the fluorophore and its dependence on the analyte of interest. Lifetime-based sensing can be preferred over intensity-based methods because the lifetime is mostly independent of the probe concentration and can be unaffected by photo bleaching or washout of the probe. Lifetimes have been measured through skin and in turbid media, opening the possibility of transdermal sensing with long wavelength light sources. Lifetime sensors have now been identified from a large number of analytes, including pH, NH₃, CO₂, Ca²⁺, Mg²⁺, immunoassay and glucose. Lifetime sensing applications for pO₂ and pCO₂ in bioprocess control have also been described.

At present most lifetime-based fluorophores display lifetimes of from 1 to 10 ns, which requires relatively fast electronics for time-domain lifetime measurements, or modulation frequencies of from 10 to 100 MHZ for frequency-domain measurements. Additionally the auto-fluorescence from most biological specimens displays decay times near 1-10 ns, making it difficult to separate the desired signal from the interfering auto-fluorescence. Such short-lived probes present obstacles to providing simple instruments for point-of-care assays and off-gating the short-lived autofluroescence in circumstances which requires high sensitivity detection.

There remains a need in the art for new and improved methods for measuring analytes.

### SUMMARY OF THE INVENTION

In accordance with the present invention, a method of measuring an analyte in a sample comprises the following steps. A metal-ligand complex probe is contacted with a sample containing analyte. The probe is bound to analyte in the sample to form an analyte-bound probe species. Both bound and unbound species of said probe exist in the sample. At least one of the bound and unbound species is fluorescent, with each of the bound and unbound species being optically distinguishable. The sample containing the bound and unbound species is excited with radiation, so as to produce a resulting emission from at least one of the bound and unbound species. The resulting emission is detected, so as to provide an optical measurement of the emission. Concentration of analyte in the sample is determined utilizing the optical measurement of the emission.

### BRIEF DESCRIPTION OF THE DRAWINGS

FIG. 1 graphically shows pH-dependent absorption spectra of [Ru(deabpy)(bpy) ₂] (PF₆)₂.

FIG. 2 graphically shows pH-dependent emission spectra of [Ru(deabpy)(bpy) ₂] (PF₆)₂. Excitation at 414 nm.

FIG. 3 graphically shows pH-dependent fluorescence intensities (557-750 nm) of [Ru(deabpy) (bpy) ₂] (PF₆)₂ in different buffer concentrations.

FIG. 4 graphically shows pH-dependent absorption of [Ru(deabpy)(bpy) ₂]²⁺at 450 nm.

FIG. 5 graphically shows wavelength-ratiometric measurements of pH using the emission intensities at 620 and 650 nm.

FIG. 6 graphically shows pH-dependent frequency-domain intensity decays of [Ru(deabpy)(bpy) ₂]²⁺at pH 2.40 (●), 7.45 (▪) and 13.53 (▴).

FIG. 7 graphically shows pH-dependent amplitude of the two decay time global analysis (Table II).

FIG. 8 graphically shows pH-dependent phase angles of [Ru(deabpy)(bpy)₂]²⁺with a modulation frequency of 700 kHz.

FIG. 9 graphically shows pH-dependent modulation of [Ru(deabpy) (bpy)₂]²⁺with a modulated frequency of 700 kHz.

FIG. 10 shows the structure of [Ru(deabpy) (bpy)₂]²⁺.

FIG. 11 shows structures of cation-sensitive metal-ligand probes.

FIG. 12 schematically shows point-of-care assays based on metal-ligand probes with a LED light source.

FIG. 13 is a schematic diagram showing instrumentation for use in accordance with one embodiment of the present invention.

FIG. 14A shows structure of an alternative metal-ligand complex which displays a different pKa value as well as absorption and emission wavelengths.

FIG. 14B shows another potential metal-ligand pH sensor in accordance with the present invention.

FIG. 15 graphically depicts data in connection with the metal-ligand complex [Ru(bpy)₂ (dcbpy)]Cl₄ showing pH-dependent intensity, phase and modulation data.

FIG. 16 graphically depicts data in connection with a metal-ligand complex [Ru(deabpy) (bpy)₂] (PF₆)₂ obtained with a LED light source.

FIG. 17 graphically depicts data in connection with a metal-ligand complex [Ru(deabpy) (bpy)₂] (PF₆)₂ obtained with a LED light source.

FIG. 18 graphically depicts data in connection with a metal-ligand complex [Ru(deabpy) (bpy)₂] (PF₆)₂ obtained with a LED light source.

FIG. 19 graphically depicts pH-dependent phase angles for [Ru(deabpy) (bpy)₂] (PF₆)₂ obtained with a LED light source.

FIG. 20 graphically depicts pH-dependent modulation data for [Ru(deabpy) (bpy)₂] (PF6)₂ obtained with a LED light source.

FIG. 21 shows the structure of [Ru(bpy)₂ (detabpy)] (PF₆)₂.

FIG. 22 shows the structure of BPTA.

FIG. 23 shows the structure of [Ru(bpy)₂ (deasbpy)] ₂₊.

FIG. 24 shows the structure of [Ru(dcabpy)₃]²⁺.

FIG. 25 shows the structure of [Re(phen) (desapy) (CO)₃ ]¹⁺.

### DETAILED DESCRIPTION OF THE PREFERRED EMBODIMENTS

According to the present invention, analytes can be sensed and measured using metal-ligand complexes utilizing lifetime measurements, intensity measurements, phase modulation fluorometry, time-domain fluorescence methods or ratiometric wavelength shifts. The invention is particularly applicable to transition metal-ligand complexes containing, for example, ruthenium, osmium, rhenium, rhodium, and the like.

The present invention is particularly applicable to utilization of time-resolved measurements, including changes in lifetime phase angles and modulation, wherein an emission is detected over time so as to provide an optical measurement of the emission over time, and the concentration of analyte in the sample is determined utilizing a time-resolved calculation of the optical measurement of the emission.

In accordance with one embodiment, the present invention provides a method in which a luminescent ligand is added to the sample to be analyzed in the form of a photoluminescent metal-ligand complex probe having intrinsic analyte-induced lifetime changes. The lifetime measurements can be performed in optically dense samples or turbid media and are independent of and/or insensitive to photo bleaching, probe wash-out or optical loss. The lifetime changes can be measured using known time-resolved or phase-modulation fluorometry methods.

In accordance with one embodiment of the method of the invention, the probe can be either fluorescent or phosphorescent.

The step of adding a luminescent metal-ligand complex probe sample to be analyzed requires matching a particular probe to a particular analyte, so that at least a portion of the sample will be bound (e.g., non-covalently bound) to the probe so that both bound and unbound species of the probe will exist. Thus, the invention differs from prior lifetime measurement methods which rely on a collisional quenching mechanism for measuring analytes. See, for example, U.S. Pat. No. 4,810,655 to Khalil et al.; and Great Britain Patent No. 2,132,348 to Demas et al.

By definition, in collisional quenching, the probe does not bind to the analyte as required by the present invention. Instead, collisional quenching requires collisional contact between the fluorophore (probe) and the quencher (analyte). For collisional quenching to occur, the quencher must diffuse to interact with the fluorophore while the latter is in the excited state. Thus, the excited fluorophore returns to the ground state without emission of a photon.

In contrast, the present invention may have an “enhancement” of the luminescence. When the fluorescent ligand binds to the analyte, there may be an increase or decrease in intensity. It is also to be emphasized that the method of the present invention is not a Foerster energy transfer mechanism, and thus is different from the method disclosed in European Patent Application 397,641 to Wolfbeis.

The present invention thus differs from oxygen sensing with metal-ligand complexes, in that in the latter case, the quenching is due to diffusion controlled collisional encounters between the oxygen and the fluorophore. In the present invention, the change in intensity or lifetime is caused by interaction of the analyte with the fluorophore resulting in a different decay time. In the case of intensity-based quenching, one of the forms can be non-fluorescent. In the case of lifetime-based sensing, both forms, with and without bound analyte, must be fluorescent so that a lifetime change can be detected upon complexation.

The method of the present invention may be useful for sensing a wide range of organic solutes such as pH, carbon dioxide, sodium ion, potassium ion, calcium ion, or magnesium ion concentrations and the like, in blood and other bodily fluids. Such measurements can be of intracellular analytes, or of extracellular analytes, depending on the location of the fluorophore.

The method of the invention is useful in either in vitro or in vivo applications, including, for example, blood gas catheters, including optical fibers, and other bedside monitors, and non-invasive blood gas measurements. Also, the invention may be used for sensors in fermentors and incubators.

As noted above, the method in accordance with certain embodiments of the invention determines and quantifies chemical analytes by changes in photoluminescence lifetimes. Embodiments of the invention can include adding a luminescent metal-ligand complex to the sample containing the analyte to be analyzed in the form of a photoluminescent probe. In accordance with certain embodiments, the probe can be either fluorescent or phosphorescent.

The invention generally requires matching a particular probe to a particular analyte, so that at least a portion of the analyte will become bound (e.g., non-covalently bound) to the probe, so that both bound and unbound (i.e., free) species of the probe will then exist within the sample. The probe can be chosen to have intrinsic analyte-induced lifetime changes, i.e., when the probe is bound to an analyte, the naturally occurring fluorescent or phosphorescent lifetime changes. It is to be understood that throughout this application the term “lifetime” refers to the photoluminescent lifetime defined as the inverse of the decay rate of the probe. In the case where two lifetimes are displayed by the probe, the term “lifetimes” refers to the measured mean or apparent lifetimes. These changes in lifetime can be measured to determine the concentration of the analyte, as will become more apparent from the discussion below.

In the context of the present invention, the term “sample” refers to compounds, surfaces, solutions, emulsions, suspensions, mixtures, cell cultures, fermentation cultures, cells, tissues, secretions and/or derivatives or extracts thereof, as well as supercritical fluids. Samples, as defined above, which can be used in the embodiments of the present invention for sensing analytes based on fluorescence lifetimes also include samples that can be clear or turbid. Such samples to be measured according to these embodiments of the present invention require only that the fluorophore used be contacted with the sample such that the analyte to be sensed influences the lifetime of the fluorophore such that the lifetime varies with the presence or amount of the analyte.

Such samples can also include, e.g., animal tissues, such as

blood, lymph, cerebrospinal fluid, bone marrow, gastrointestinal contents, and portions, cells or internal and external secretions of skin, heart, lung and respiratory system, liver, spleen, kidney, pancreas, gall bladder, gastrointestinal tract, smooth, skeletal or cardiac muscle, circulatory system, reproductive organs, auditory system, the autonomic and central nervous system, and extracts or cell cultures thereof. Such samples can be measured using methods of the present invention in vitro, in vivo and in situ.

Such samples can also include environmental samples such as earth, air or water samples, as well as industrial or commercial samples as compounds, surfaces, aqueous chemical solutions, emulsions, suspensions or mixtures.

Additionally, samples that can be used in the method of the present invention include cell culture and fermentation media used for growth of prokaryotic or eukaryotic cells and/or tissues, such as bacteria, yeast, mammalian cells, plant cells and insect cells.

The term “analyte” in the context of the present invention refers to elements, ions, compounds, or salts, dissociation products, polymers, aggregates or derivatives thereof. Examples of analytes that can be measured in the method of the present invention include, e.g., H⁺, Ca²⁺, Mg²⁺, Na⁺, K⁺, NH₃⁺, PO ₄²⁻and the like, or other compounds containing these ionic solutes, including salts, derivatives, polymers, dissociation products, or aggregates thereof.

The method of the invention further includes exciting the tagged sample with radiation from any suitable radiation source, such as a laser, an light emitting diode or the like. Light sources suitable for use in the methods of the present invention, also include noble gas light sources such as helium, neon, argon, krypton, xenon, and radon, and combinations, thereof. Light sources can include gas lamps or lasers which provide uniform light that has been filtered, polarized, or provided as a laser source, such as a coherent wave (CW) laser or a pulsed laser. Specified impurities can be added to the above described noble gas light sources to provide suitable light sources for use in the present invention with varying wavelengths such as emission and excitation wavelengths. Such impurities include Group II metals, such as zinc, cadmium, mercury, strontium, selenium and ruthenium. A green helium-neon laser can be used in accordance with one embodiment of the present invention, and is inexpensive and reliable.

In one embodiment, the intensity of the excitation radiation is modulated at a particular modulation frequency and the lifetime determined using known phase-modulation, i.e., frequency domain, techniques. Alternatively, a pulsed radiation source may be used and the lifetime of the sample determined using known time resolved methods. Both phase-modulation and time-resolved fluorometry methods are well known in the prior art, see Lakowicz, Principles of Fluorescence Spectroscopy, Plenum Press, 1983, Chapter 3. However, current instrumentation renders the phase modulation method more expedient. The phase-modulation method is further discussed below, but it is to be understood that these same principles generally apply to time-resolved measurements.

When the sample is excited with radiation whose intensity is modulated, for example, in a sinusoidal manner, the time lag between absorption and emission causes the emission to be delayed in phase and demodulated relative to the excitation radiation. As discussed above, when a luminescent ligand is added to the sample, at least a portion of the analyte will bind with the ligand, i.e., probe, so that both bound and unbound species of the probe will exist within the sample. The probe is preferably chosen so that there will be a significant difference in the luminescent lifetime between the bound and unbound species. The phase shift and the corresponding demodulation factor m can be measured and used to calculate the photoluminescent lifetime based on well known formulae. See, Lakowicz, supra. It is desirable to select the modulation frequency in a range that coincides with the frequency at which the differences between the measured phase angles and the demodulations of the bound and unbound ligand are maximal.

Thus, according to a method according to the invention, the emission radiation is detected, the phase shift (in degrees) and the demodulation factor m (as a percentage change) are measured, and the apparent photoluminescent lifetime may be calculated therefrom. An absolute value of difference in phase angle between the bound and free unbound forms of the ligand of at least about 10°, e.g., on the order of 10-60° at a preselected frequency, and a difference in modulation factor of at least about 10%, e.g., on the order of about 10-87%, can be utilized. These ranges of phase angles and modulation factors offer a combination of precision and dynamic range.

The absolute values of the frequency-dependent phase differences and demodulations can be determined by the photoluminescent lifetimes of the free and bound ligand. In addition, if the excitation and emission spectra are not congruent, effects can occur whereby at particular wavelengths of excitation or emission one form or the other of the probe is preferentially excited or its emission preferentially observed. In such cases, the apparent analyte sensitive concentration range (for pH, the apparent pKa) varies with excitation or emission wavelength. This can be advantageous where the method of the present invention allows a range of concentrations that can be accurately measured with a single probe to be easily varied by selection of the appropriate excitation and/or emission wavelengths.

The present invention is applicable to a method of measuring an analyte utilizing probes as disclosed herein and their equivalents. These probes include [Ru(deabpy) (bpy)₂]²⁺, [Ru(deabpy) (bpy)₂] (PF₆)₂, [Ru(bpy)₂ (detabpy)] (PF₆)₂, BPTA, [Ru(bpy)₂ (deasbpy)]²⁺, [Ru(dcabpy)₃]²⁺, [Re(phen)(desapy)(CO)₃]¹⁺and the like.

Certain probes described in the present application display absorption in the blue region of the spectrum and long decay times over 100 ns. As a result it is possible and preferable to use amplitude modulated light emitting diodes (LEDs) as the excitation source. It is known that LEDs are inexpensive and reliable, and easily modulated at the frequencies needed for use with long decay time probes.

| | |
|---|---|
| bpy | 2,2′-bipyridine |
| deabpy | 4,4′-diethylaminomethyl-2,2′-bipyridine |
| deasbpy | 4-4′-bis(4″,4″′-(N,N-diethylamino)styryl)- |
| | 2,2′-bipyridine |
| desapy | 4-(4′-(N,N-diethylamino)styryl)-pyridine |
| phen | 1,10-phenanthroline |
| LED | light emitting diode |
| MLC | metal-ligand complex |

### EXAMPLE 1

Herein is described the synthesis and fluorescence spectral characterization of a pH-sensitive metal-ligand complex, [Ru(deabpy)(bpy)₂]²⁺, where deabpy is 4,4′-diethylaminomethyl-2,2′-bipyridine. This metal-ligand complex (MLC) was found to display pH dependent intensities, emission spectra, and decay times, with the changes centered near the physiological useful pH value of 7.5. The apparent pKₐ values were not found to be dependent on ionic strength. The compound was found to be useful for lifetime-based sensing by phase-modulation fluorometry. Global analysis of the intensity decays over a range of pH values revealed two decay times of 235 and 380 ns, associated with the protonated and unprotonated forms, respectively. Because of its long decay time pH sensing was accomplished by phase-modulation fluorometry with a conveniently low modulation frequency of 700 kHz. The lifetime data were obtained with either an amplitude-modulated laser and with an amplitude-modulated blue light emitting diode. This pH sensitive complex also displays a modest spectral shift with change in pH allowing its use as a wavelength-ratiometric MLC probe. One can imagine lifetime sensors for a variety of blood cations and point-of-care assays based on long lifetime metal-ligand complexes with simple solid state light sources and detectors.

Among the various optical methods, fluorescence detection offers the advantages of high sensitivity and ion-selective fluorescence probes. The current status of fluorescence sensing has described in recent literature. See, e.g., Proceedings of the 2nd European Conference on Optical Chemical Sensors and Biosensors, EUROPT(R)ODE II (F. Baldini, Ed.). Florence, Italy, April 1994, Sensors and Actuators B., pp. 439. Proceedings of the 1st European Conference on Optical Chemical Sensors and Biosensors, EUROPT(R)ODE I (O. S. Wolfbeis, Ed.). Graz, Austria, April 1992, Sensors and Actuators B., pp. 565. Topics in Fluorescence Spectroscopy, Vol. 4: Probe Design and Chemical Sensing (1994). (J. R. Lakowicz, Ed.), Plenum Press, New York. pp. 501. Fluorescent Probes in Cellular and Molecular Biology (1994). Slavik, J., CRC Press, Boca Raton, pp. 295. Advances in Fluorescence Sensing Technology II (1995). (J. R. Lakowicz, Ed.) San Jose, Calif., SPIE Proc., Vol. 2388. pp. 598. Potential Applications of Lifetime-Based Phase-Modulation Fluorometry for Bioprocess and Clinical Sensing (1995). Bambot, S. B., J. R. Lakowicz and G. Rao. Trends in Biotechnology, 13:106-116.

During the past several years there has been increasing interest in lifetime-based sensing. See, e.g., Lifetime-Based Sensing. Szmacinski, H. and Lakowicz, J. R. (1994) In: Topics in Fluorescence Spectroscopy, Vol. 4: Probe Design and Chemical Sensing (J. R. Lakowicz, Ed.), Plenum Press, 295-334. Luminescence Decay Time-Based Optical Sensors: Principles and Problems (1993). Lippitsch, M. E and S. Draxler. Sensors and Actuators B, 11:97-101. Time-resolved Fluorescence Spectroscopy for Chemical Sensors (1996). Draxler, S. and M. E. Lippitsch. Appl. Optics, 35(21):4117-4123.

In this method the analyte concentration is determined from the decay time of the fluorophore and its dependence on the analyte of interest. Lifetime-based sensing can be preferred over intensity-based methods because the lifetime is mostly independent of the probe concentration and can be unaffected by photobleaching or washout of the probe. As noted above, the possible mechanisms of lifetime-based sensing have been reviewed. Lifetimes have been measured through skin and in turbid media, suggesting the possibility of trans-dermal sensing with long wavelength light sources. Lifetime sensors have now been identified from a large number of analytes, including pH, NH₃, CO₂, Ca²⁺, Mg²⁺, Cu²⁺, immunoassays and glucose. Practical sensing applications for pO₂ and pCO₂ in bioprocess control have also been described. See, e.g., Sensing Oxygen Through Skin Using a Red Diode Laser and Fluorescence Lifetimes (1995). Bambot, S. B., G. Rao, Romauld. M., G. M. Carter, J. Sipior, E. Terpetschnig and J. R. Lakowicz. Biosensors & Bioelectronics, 10(6/7):643-652. Frequency-domain Lifetime Measurements and Sensing in Highly Scattering Media (1995). Szmacinski, H. and J. R. Lakowicz. Sensors and Actuators B., 30:207-215. Optical Measurements of pH Using Fluorescence Lifetimes and Phase-Modulation Fluorometry (1993). Szmacinski, H.and J. R. Lakowicz. Anal. Chem., 65:1668-1674. Lifetime-Based Optical Sensing of pH Using Resonance Energy Transfer in Sol-Gel Films (1994). Bambot, S., J. Sipior, J. R. Lakowicz and G. Rao. Sensors and Actuators B: Chemical, 22:181-188. A Lifetime-Based Fluorescence Resonance Energy Transfer Sensor for Ammonia (1995). Chang, Q., J. Sipior, J. R. Lakowicz and G. Rao. Anal. Biochem., 232:92-97. A Lifetime-Based Optical CO₂ Gas Sensor with Blue or Red Excitation and Stokes or Anti-Stokes Detection (1995). Sipior, J., S. Bambot, Romauld M., G. M. Carter, J. R. Lakowicz and G. Rao. Anal. Biochem., 227:309-318. Possibility of Simultaneously Measuring Low and High Calcium Concentrations Using Fura-2 and Lifetime-Based Sensing (1995). Szmacinski, H. and J. R. Lakowicz. Cell Calcium, 18:64-75. Fluorescence Lifetime Characterization of Magnesium Probes. Improvement of Mg²⁺Dynamic Range and Sensitivity Using Phase-Modulation Fluorometry (1996). Szmacinski, H. and J. R. Lakowicz. J. Fluoresc., 6 (2):83-95. Fluorescence Lifetime Sensor of Copper Ions in Water (1996). Birch, D. J. S., O. J. Rolinski and D. Hatrick. Rev. Sci. Instrum., 67(8):2732-2737. Homogeneous Model Immunoassay of Thyroxine by Phase-Modulation Fluorescence Spectroscopy (1992). Ozinskas, A. J., H. Malak, J. Joshi, H. Szmacinski, J. Britz, R. B. Thompson, P. A. Koen and J. R. Lakowicz. Anal. Biochem., 213:264-270. Optical Sensing of Glucose Using Phase-Modulation Fluorometry (1993). Lakowicz, J. R. and B. P. Maliwal. Anal. Chim. Acta., 271:155-164. Phase Fluorometric Sterilizable Optical Oxygen Sensor (1994). Bambot, S., R. Holavanahali, J. R. Lakowicz, G. Carter and G. Rao. Biotechnol. Bioeng., 43:1139-1145. A Phase Fluorometric Optical CO₂ Gas Sensor for Fermentation Off-Gas Monitoring (1996). Sipior, C. J., L. Randers-Eichhorn, J. R. Lakowicz, G. Carter and G. Rao. Biotech. Prog., 12:266-271. Non-Invasive Oxygen Measurements and Mass Transfer Limitations in Tissue Culture Flasks (1996). Randers-Eichhorn, D. L., R. Bartlett, D. Frey and G. Rao. Biotechnol. Bioeng., 51:466-478.

As further noted above, at present most lifetime-based fluorophores display lifetimes from 1 to 10 ns, which requires relatively fast electronics for time-domain lifetime measurements or modulation frequencies from 10 to 100 MHZ for frequency-domain measurements. Additionally, the auto-fluorescence from most biological specimens displays decay times near 1-10 ns, making it difficult to separate the desired signal from the interfering auto-fluorescence. The availability of longer lived probes permits design of simple instruments for point-of-care assays and off-gating the short lived autofluorescence in circumstances which requires high sensitivity detection. In fact, a solid state phase-modulation fluorometer has already been reported. See, Detection of Fluorescence Lifetime Based on Solid State Technology and Its Application to Optical Oxygen Sensing (1995). Gruber, W. R., O'Leary, P. And Wolfbeis, O. S., SPIE Proc., 2388:148-158.

Use of long-lifetime metal-ligand probes may be useful in fluorescence microscopy and for chemical imaging by lifetime imaging. See, e.g., Fluorescence Lifetime-Imaging of Intracellular Calcium in COS Cells Using Quin-2 (1994). Lakowicz, J. R., H. Szmacinski, K. Nowaczyk, W. J. Lederer, M. S. Kirby and M. L. Johnson. Cell Calcium, 15:7-27. Fluorescence Lifetime Imaging of Free and Protein-Bound NADH (1992). Lakowicz, J. R., H. Szmacinski, K. Nowaczyk and M. L. Johnson. Proc. Natl. Acad. Sci. U.S.A., 89:1271-1275. High-Speed Fluorescence Microscopy: Lifetime Imaging in the Biomedical Sciences (1995). Periasamy, A., X. F. Wang, P. Wodnick, G. W. Gordon, S. Kown, P. A. Diliberto and B. Herman. J. S. M. A., 1(1):13-23.

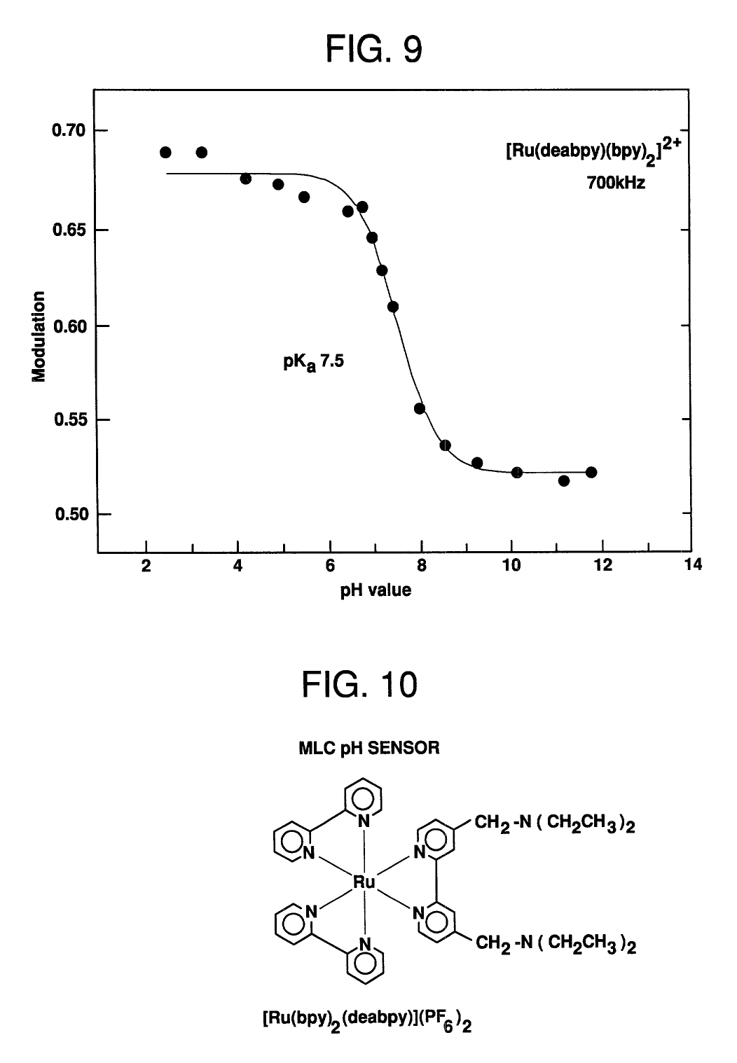

Herein is described the synthesis and spectral properties of a long lived metal-ligand complex (MLC) which displays pH sensitive emission in the physiological range from 6 to 8. This compound [Ru(deabpy) (bpy)₂]²⁺(FIG. 10) was found to display pH sensitive intensities, phase angles and modulations with an apparent pKₐ near 7.5. This pH-dependent MLC can be regarded of the first of a series of cation-sensitive probes which display decay times in excess of 200 ns.

### Materials and Methods

Synthesis of [Ru (deabpy) (bpy)₂] (PF₆)₂

The synthetic procedure for preparation of [Ru(deabpy) (bpy)₂] (PF₆)₂ followed published procedures [see, Luminescent pH Sensors Based on Di(2,2′bipyridyl) (5,5′diaminomethyl-2,2′bipyridyl)-ruthenium (II) Complexes (1992). Grigg, R. and W. D. J. Amilaprasadh Norbert. J. Chem. Soc. Chem. Commun., 1300-1302; Formation of Thin Polymeric Films by Electropolymerization. Reduction of Metal Complexes Containing Bromomethyl-Substituted Derivatives of 2,2′Bipyridine. Gould, S., G. F. Strouse and B. P. Sullivan. Inorg. Chem., 30:2942-9.] with slight modification. The (CH₂Br)₂bpy was prepared by following reported methods [see, Formation of Thin Polymeric Films by Electropolymerization. Reduction of Metal Complexes Containing Bromomethyl-Substituted Derivatives of 2,2′Bipyridine. Gould, S., G. F. Strouse and B. P. Sullivan. Inorg. Chem., 30:2942-2949; Synthesis and Coordination Chemistry of 1-(2′,2″-bipyridyl-5-yl-methyl)-1,4,8,11-tetrazacyclotetradecane of Ni^{II} or Cu^{II} in Cyclam Cavity (bpy 2,2′ bipyridine; cyclam =1,4,8,11-tetra-aza cyclotetradecane (1992). Rawle, S. C., P. Moore and N. W. Alcock. J. Chem. Soc. Chem. Commun., 684-] and resulting compound was purified by column chromatography [30]. The ligand 4,4′-diethylaminomethyl-2,2′-bipyridine (deabpy) was prepared by refluxing (CH₃CH₂)₂ NH with (CH₂Br)₂bpy in CCl₄ and purified by using a silica column using acetone/dichloromethane solvent mixture. Ru(bpy)₂Cl₂ was stirred in acetone for about two hours with silver triflate, the white precipitate of silver chloride was removed, and the resulting red color solution was stirred with deabpy ligand for about six hours. The acetone was removed and the residue redissolved in water, precipitated with ammonium hexafluorophosphate and filtered. The brick red color solid was redissolved in acetonitrile and chromatograph with an acetonitrile/toluene mixture over alumina. The [Ru(deabpy) (bpy)₂] (PF₆)₂ was characterized by proton NMR.

Instrumentation and Procedures

Chemicals and solvents were purchased from Aldrich and used without further purification. Absorption spectra were measured using a Perkin Elmer lambda 6 UV/Vis spectrophotometer. Observed were two isosbestic points at 414 nm and 475 nm. The absorbance at 450 nm of different samples were measured to obtain the ground state pKₐ.

Ru(bpy)₂ (deabpy) (PF₆)₂ solutions at different pH value were prepared by dissolving equal amount of aqueous Ru(bpy)₂ (deabpy) (PF₆)₂ in different buffer solutions. From pH 2 to pH 4.7, we used citrate buffer; from pH 4.8 to pH 6.3 we used acetate buffer; from pH 6.4 to pH 7.8 we used phosphate buffer; from pH 7.8 to pH 9.0 we used tris buffer, from pH 9.2 to pH 11 we used carbonate/bicarbonate buffer, from pH 11 to pH 12 we used dibasic sodium phosphate/sodium hydroxide buffer. Unless stated otherwise the buffer concentrations were 20 mM and contained 0.1 M potassium chloride to maintain ionic strength. In order to determine if the pKa was dependent on the buffer concentration, we also prepared sample solutions in 50 mM and 100 mM phosphate with and buffer with pH values between 6 and 8 and compared their total fluorescence intensity from 550 nm and 750 nm.

The fluorescence emission spectra were measured using Aminco Bowman Series AB2 Luminescence Spectrometer with the excitation wavelength of 414 nm. The acidic sample (at low pH) had an emission maximum at 650 nm, and the basic sample had an emission maximum at 620 nm. The emission intensity ratios (620 nm/650 nm) of the different sample were also recorded.

For the phase/modulation measurements (FIGS. 6-9), an air-cooled Argon ion laser (output at 488 nm) was used as the excitation light source, and the modulation frequency was set at 700 kHz. On the emission side, a long-wave pass filter was used to collect the fluorescence with wavelength longer than 600 nm. The reference solution used here was an aqueous solution of Texas Red with a reference lifetime of 4 ns. For the lifetime measurements, we used the same instrumentation and reference solution, and 23 different modulation frequencies ranging from 11 kHz to 2 MHZ.

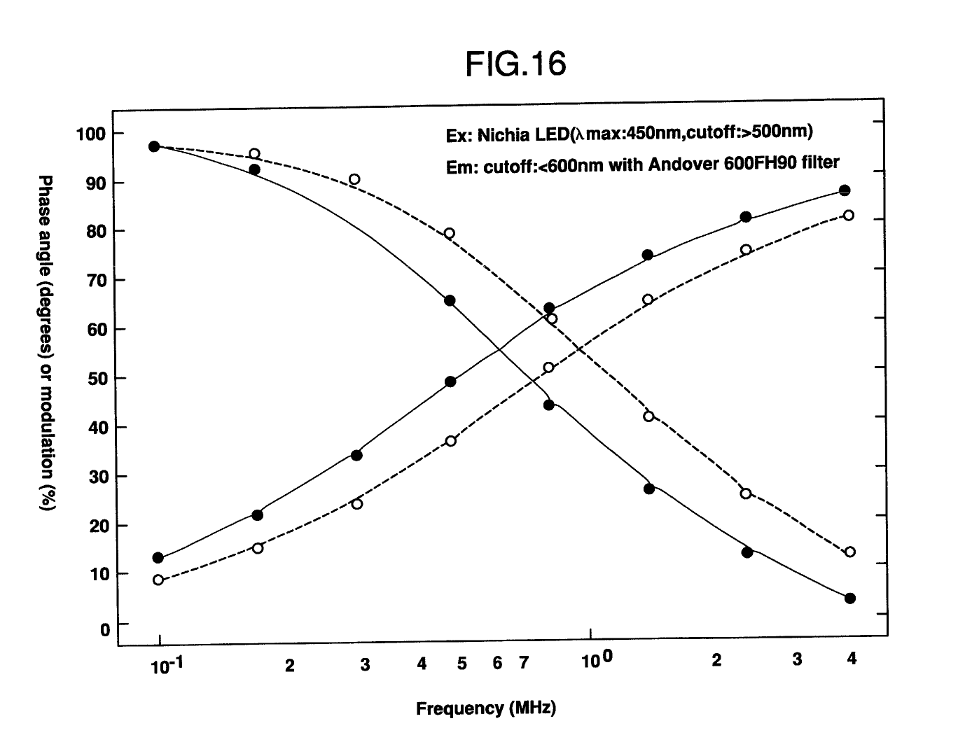

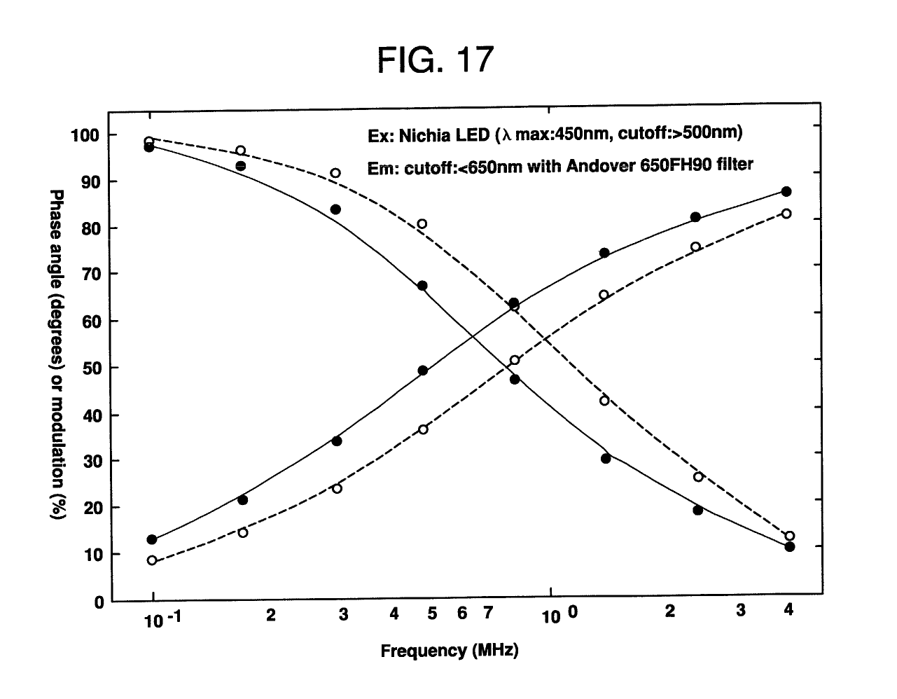

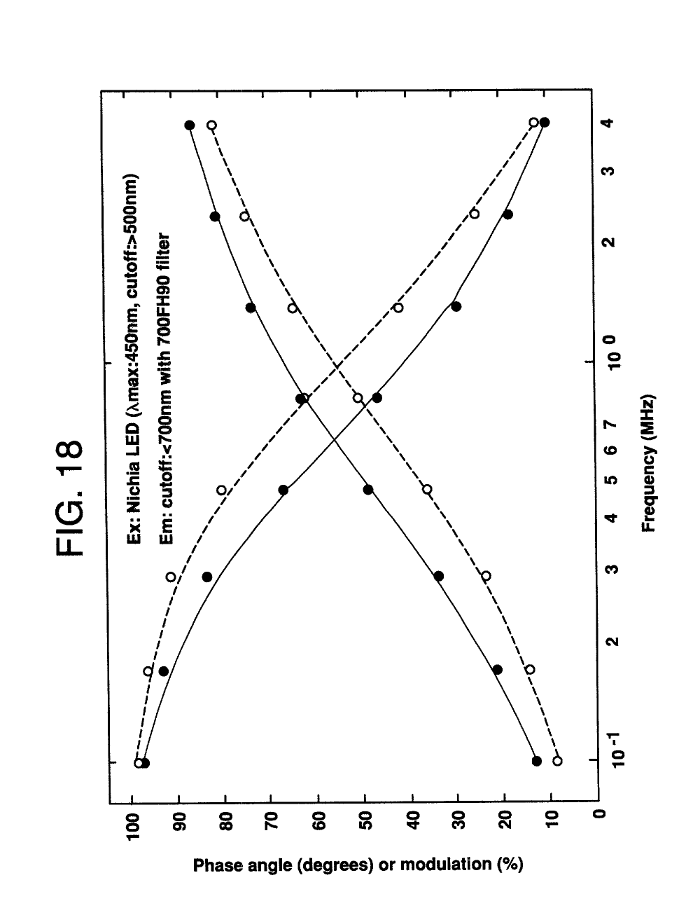

Phase modulation measurements (FIGS. 16-20) were also performed with a Nichia blue LED (NLPB500, Nichia America Co., Lancaster, Pa. with maximum output at 450 nm) as the excitation light source. In this case the measurements were performed on an ISS K2 Multifrequency Phase and Modulation Fluorometer (Champaign, Ill.). A set of Andover 500FL07, 600FL07 and 700FL07 short-wave pass filters (Salem, N.H.) was added in the excitation path to ensure the cut-off of light from the LED with wavelengths longer than 500 nm. On the emission side, an Andover 600FH90 long-wave-pass filter was used to collect the fluorescence with wavelengths longer than 600 nm. An 650FH90 or 700FH90 filter was used to replace the 600FH90, where necessary. The reference solution used for the lifetime measurement was a 0.5% solution of Du Pont Ludox HS-30 colloidal silica in water, with the intensity matched to that of the sample by using neutral-density filter(s) in its emission path. All experiments were performed at an ambient temperature. In this case single frequency measurements were performed at 823 kHz.

Single and multi-exponential intensity decays were recovered from the multi-frequency data as described previously [see, Construction and Performance of a Variable-Frequency Phase-Modulation Fluorometer (1985). Lakowicz, J. R. and B. P. Maliwal. Biophys. Chem., 21:61-78; Frequency-Domain Fluorescence Spectroscopy (1991) in Topics in Fluorescence Spectroscopy, Vol. 1: Techniques, (Lakowicz, J. R., Ed.). Plenum Press, New York, pp. 293-355]. The data were analyzed globally in terms of the multi-exponential model

$${I}_{k} ( t ) = {\sum }_{i = 1 , k}^{2} {α}_{ik} {e}^{- t / {τ}_{i}} \qquad ( 1 )$$

where Iₖ(t) are the intensity decays at each pH (k) value, Tᵢ are the decay times and αᵢₖ are the amplitudes. For the global analysis we assumed that the αᵢₖ values would depend on pH, but that the two lifetimes would be independent of pH. The goodness-of-fit was judged by the usual X_{R}² criterion with assumed uncertainties in phase δp=0.2° and modulation δm=0.005.

Results

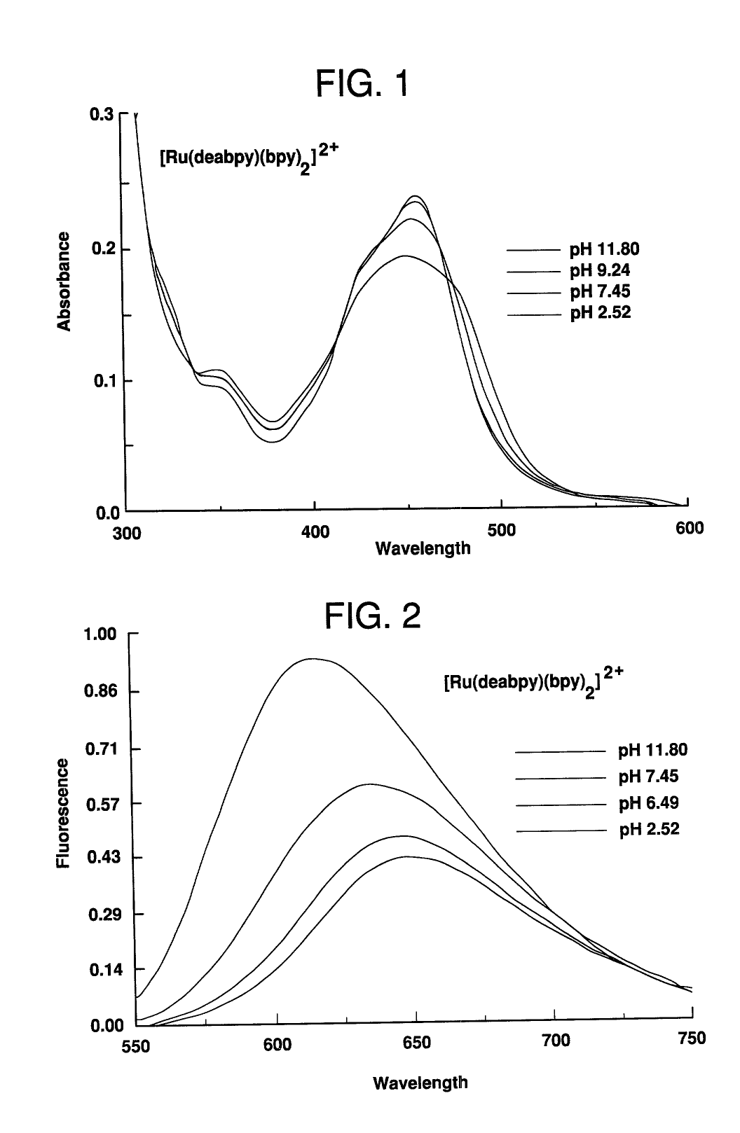

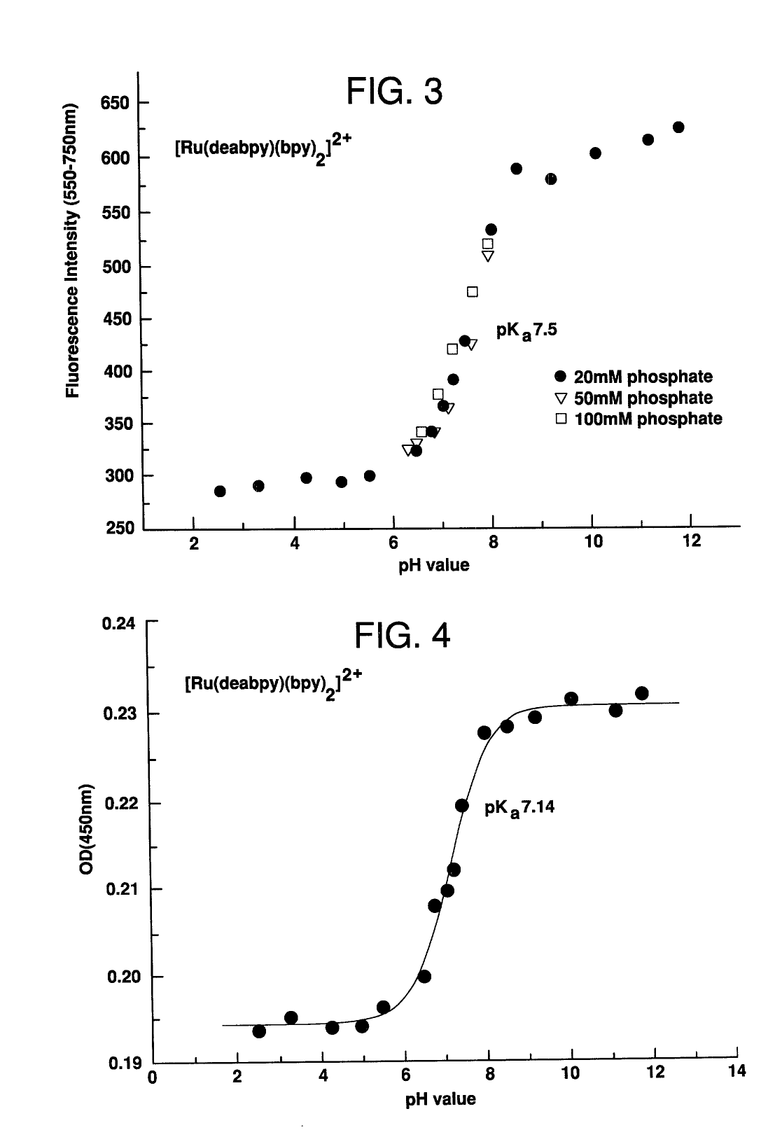

Absorption and emission spectra of [Ru(deabpy) (bpy)₂]²⁺at pH values from 2 to 12 are shown in FIGS. 1 and 2, respectively. Only modest changes are seen in the absorption spectrum, but the emission spectrum increases about 3-fold as the pH increases from 2.52 to 11.8. The pH-dependent intensity changes are shown in FIG. 3, and reveal a pKa value near 7.5. This pKa value is ideally suited for measurements of blood pH, where the clinically relevant range is from 7.35 to 7.46, with a central value near 7.40. In addition, much cell culture work is performed near pH 7.0-7.2. We attribute the changes in absorption and emission to deprontonation of the amino groups on [Ru(deabpy) (bpy)₂]²⁺(FIG. 10).

We were pleasantly surprised by the pKa value near 7.5, as we expected a higher pKa near 9 based on the structures shown in FIG. 10. In fact, we initially attempted to synthesize a different structure which contained hydroxyl groups on the terminal methyl groups. These hydroxyl groups were thought to be needed to obtain a pKa near 7.5, based on their presence in the widely used buffer tris, tris(hydroxymethyl)aminomethane. However, we had difficulties synthesizing or isolating the hydroxyl containing compound, and decided to synthesize and test [Ru(deabpy)(bpy)₂]²⁺as an initial step.

We also considered whether the pKₐ observed by fluorescence is in fact the ground state pKₐ. The ground state pKₐ was determined from the changes in absorption at 450 nm (FIG. 4). In this case the pKₐ was found to be 7.14, somewhat lower than the value of 7.5 observed by fluorescence. This small difference in pKₐ values is not surprising, as metal ligand complexes with ionizable diimine ligands often display different pKₐs in the ground and excited states. Importantly, the difference is not large, and our probe does not seem to be sensitive to ionic strength. The same apparent pKₐ values were observed in 20, 50 and 100 mM phosphate buffer (FIG. 3). We will describe fluorescence changes as due to ionization events at pKₐ values, but we recognize that the ground state and excited state pKₐ values may be slightly different.

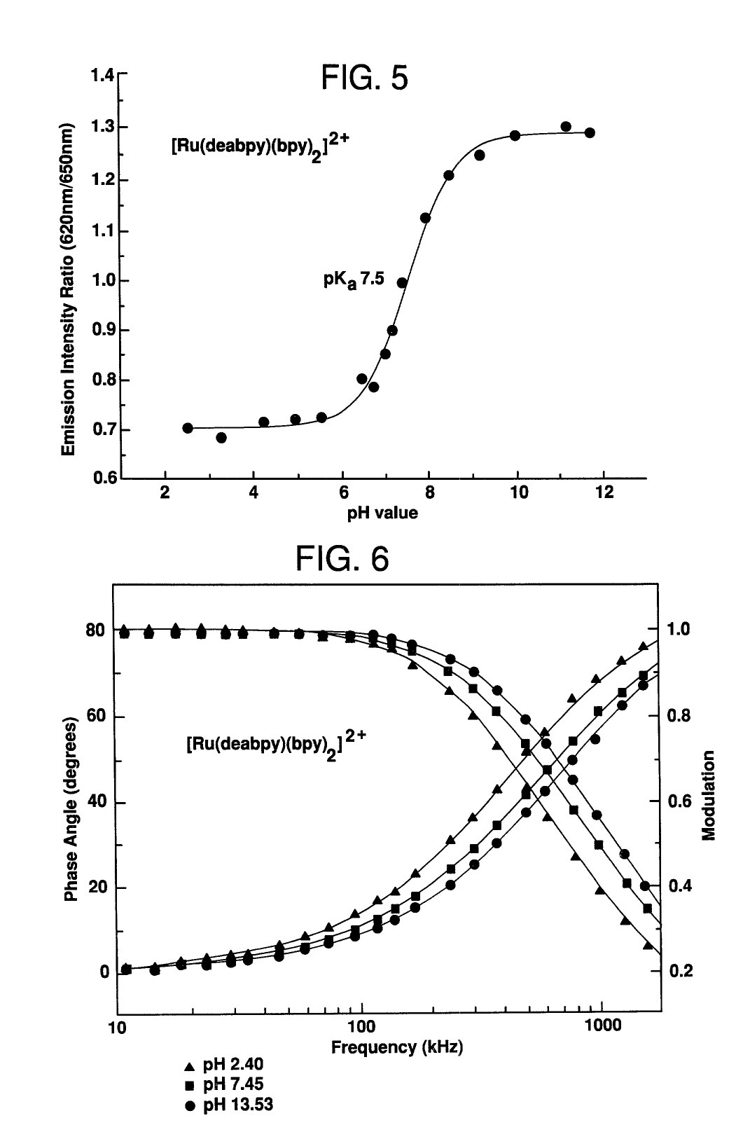

FIG. 2 shows that the emission spectrum shifts to longer wavelengths as the amino groups are protonated at low pH. This suggests the use of [Ru(deabpy) (bpy)₂]²⁺as a wavelength-ratiometric probe. Such ratiometric probes are already in widespread use for measurement of Ca²⁺[34-35] and pH [36-37], but these are not MLC probes and they display ns decay times. We used the emission spectra at various pH values to obtain a wavelength-ratiometric calibration curve (FIG. 5). To the best of our knowledge [Ru(deabpy) (bpy)₂]²⁺is the first MLC probe which can be used as a ratiometric probe. See, e.g., Fluorescent Indicators of Ion Concentrations (1989). Tsien, R. Y. Meth. Cell Biol., 30:127-156; Fluorescence Ratio Imaging: A New Window into Intracellular Ionic Signalling (1986). Tsien, R. Y. and M. Poenie. Trends Biochem. Sci., 11:450-455; Optical Measurements of pH Using Fluorescence Lifetimes and Phase-Modulation Fluorometry (1993). Szmacinski, H. and J. R. Lakowicz. Anal. Chem., 65:1668-1674; Spectral and Photophysical Studies of Benzo[c]xanthene Dyes: Dual Emission pH Sensors (1991). Whitaker, J. E., R. P. Haughland, F. G. Prendergast. Anal. Biochem., 194:330-344.

The emission shift to longer wavelengths at low pH (FIG. 2) seems to be generally understandable in terms of the electronic properties of the excited MLCs. The long wavelength emission is thought to result from a metal-to-ligand charge transfer (MLCT) state in which an electron is donated from Ru to the ligand. The protonated form of deabpy is probably a better electron acceptor, lowering the energy of the MLCT state, shifting the emission to longer wavelengths and thereby decreasing the lifetime. We observed that the emission spectrum of [Ru(dcbpy)(bpy)₂]²⁺where dcbpy is 4,4′-dicarboxy-2,2′-bipyridine, displays a red shift relative to Ru(bpy)₃ [see, Metal-Ligand Complexes as a New Class of Long-Lifetime Fluorophores for Protein Hydrodynamics (1995). Terpetschnig, E., H. Szmacinski, H. Malak and J. R. Lakowicz. Biophys. J., 68:342-350; Fluorescence Polarization Immunoassay of a High Molecular Weight Antigen Based on a Long-Lifetime Ru-Ligand Complex (1995). Terpetschnig, E., H. Szmacinski and J. R. Lakowicz. Anal. Biochem., 227:140-147].

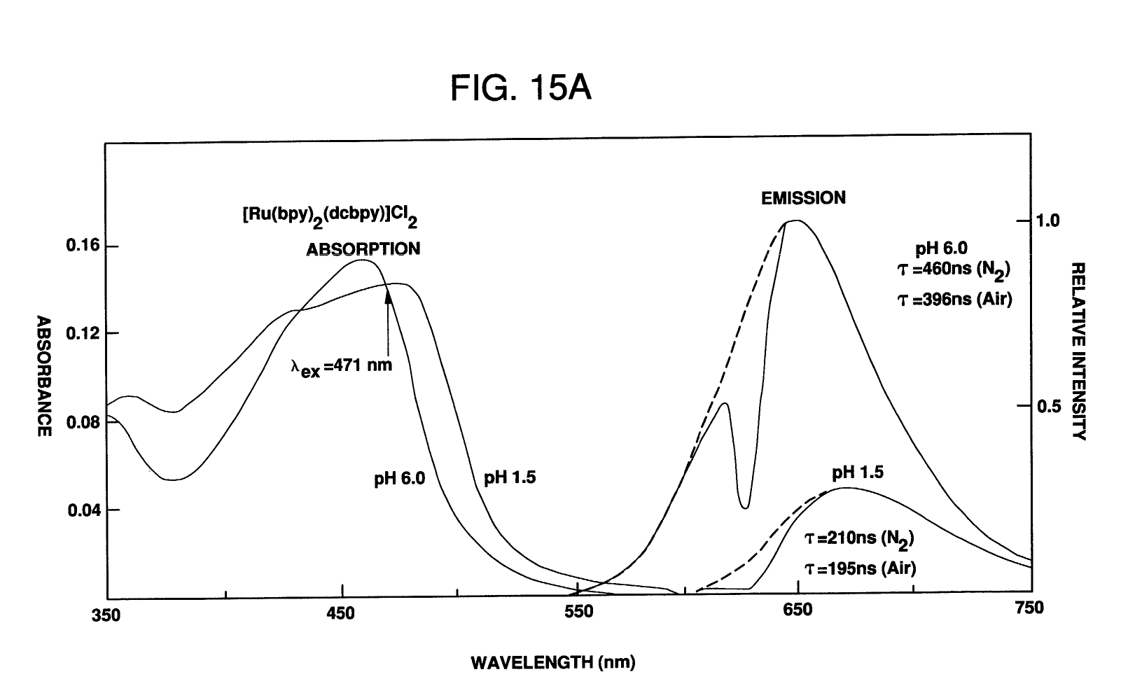

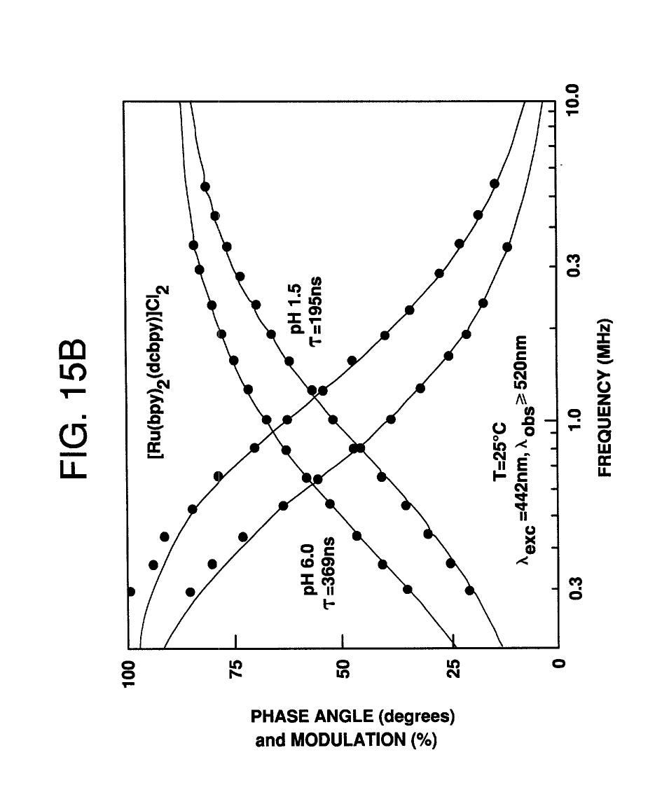

The dcbpy ligand is probably a better electron acceptor than bpy. These results suggest a general approach to designing wavelength-ratiometric MLC probes based on cation-dependent changes in the electron affinity of the ligand. In fact, [Ru(deabpy)(bpy)₂] displays pH-dependent lifetimes (FIG. 15), but the pkₐ may be too low for medical applications. It could be used at a pH in the range of pH 2 to 5.

Examination of the emission spectra (FIG. 2) reveals that the probe is fluorescent in both forms, protonated and unprotonated. It meets the requirements as a lifetime probe because each form is fluorescent and may display distinct decay times. Frequency-domain intensity decays of [Ru(deabpy)(bpy)₂]²⁺are shown in FIG. 6. At low pH with protonated amino groups the mean decay time is near 240 ns, and at high pH the mean decay time increases to near 390 ns. The intensity decay was found to be reasonably fit to a single exponential at each pH value (Table I). The decay times were difficult to resolve at a single pH value, so that only a modest decrease in X_{R}² was found for the double exponential fit (Table I). However the apparent decay time found from the single exponential fit increases with increasing pH. Similar intensity decays were found whether the entire emission above 600 nm was observed, or if one just observed the red side of the emission above 700 nm.

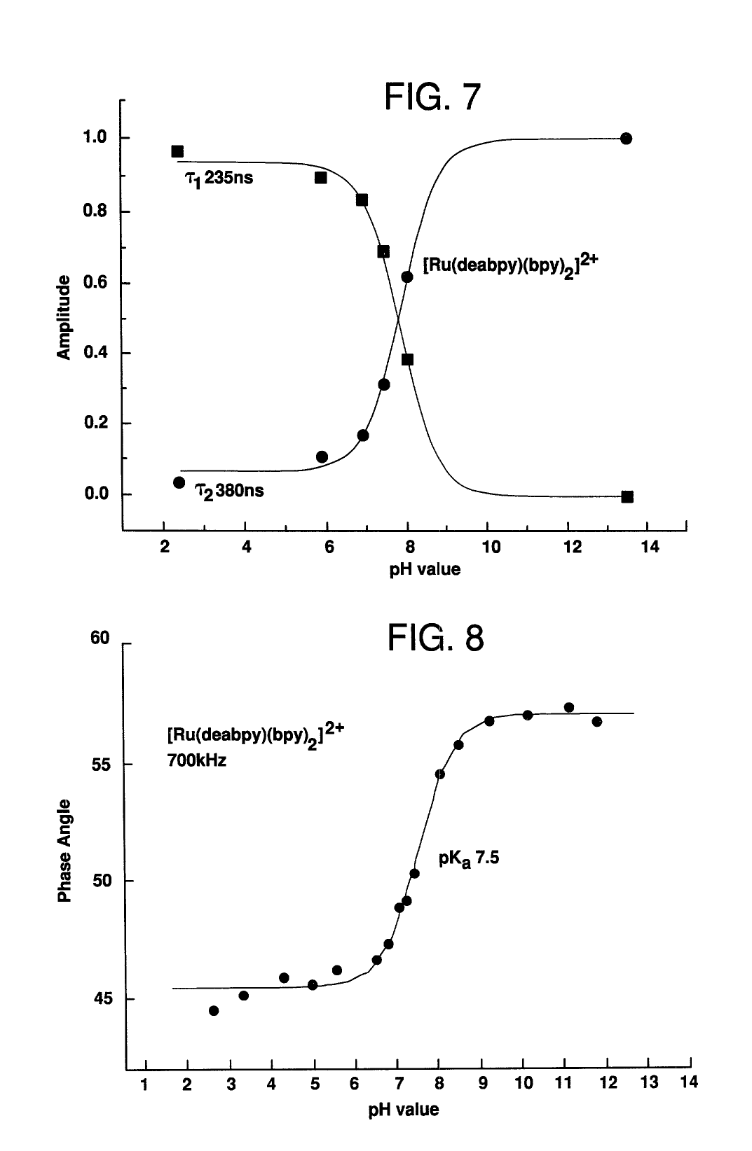

The intensity decay may be a multi-exponential at intermediate pH values, where both species are present. Hence we examined the intensity decays at several pH values between 2 and 12. Because of the closely spaced decay times it was difficult to recover the two decay times at each pH. Hence we performed a global analysis in which the pre-exponential factors (αᵢₖ values) were assumed to be pH dependent, and the same two decay times would be present at all pH values. For a global analysis the frequency-domain data were only poorly fit by the single lifetime model, as seen from the elevated of X_{R}²−124 value (Table II). Analysis in terms of the two lifetime models resulted in a reduced value of X_{R}²=4.66. The results of this global analysis are shown graphically in FIG. 7. These data show that the amplitude associated with the 235 ns decay time decreases with increased pH near pH 7.5, and that the amplitude associated with the 380 ns component increases at this same pH value. Importantly, the two recovered decay times were comparable to those observed at pH 2 and pH 12 (Table I), supporting the assignment of the 235 ns decay time to the protonated form and the 380 ns decay time to the unprotonated form of [Ru(deabpy) (bpy)₂]²⁺.

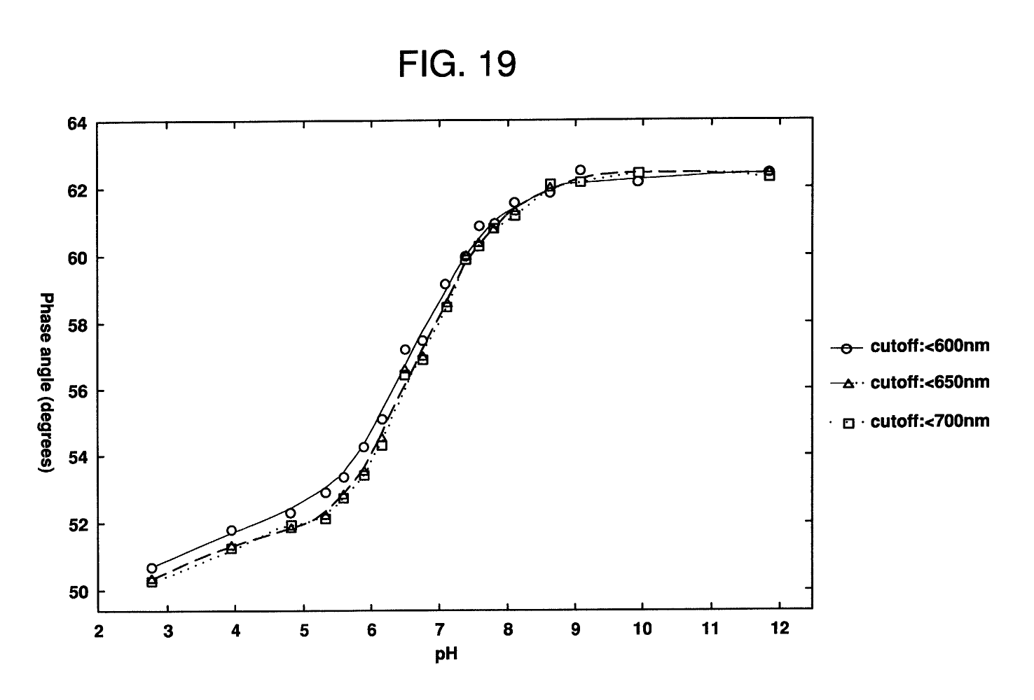

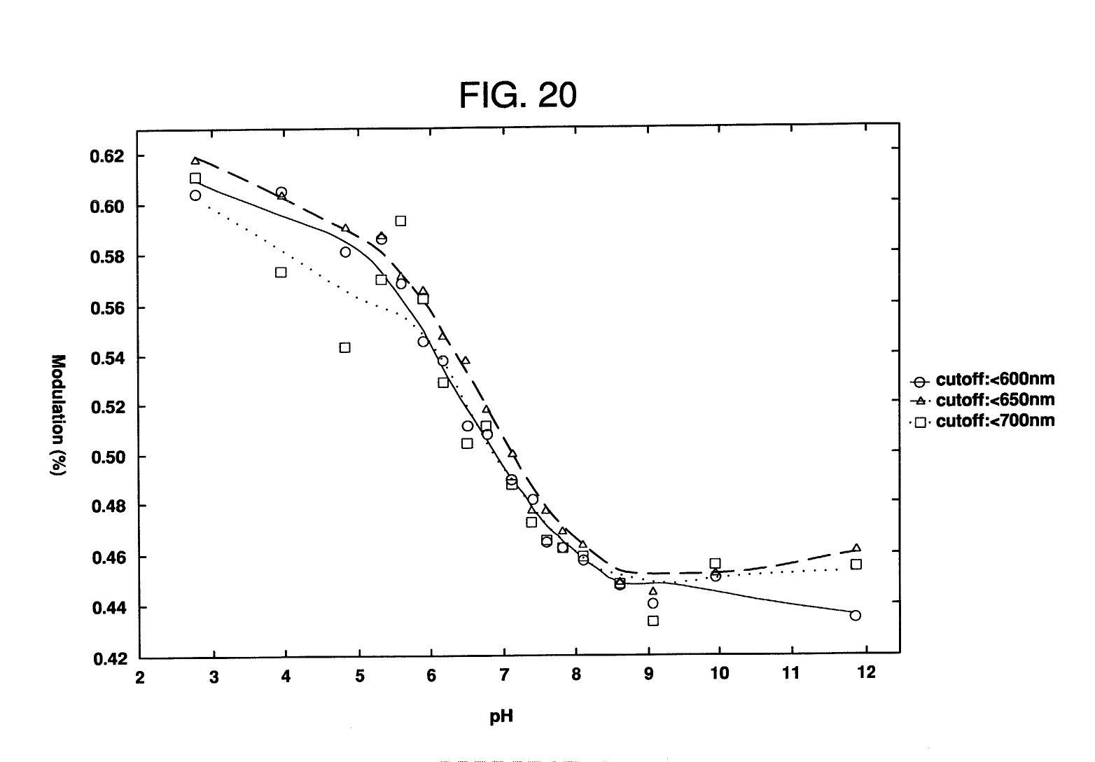

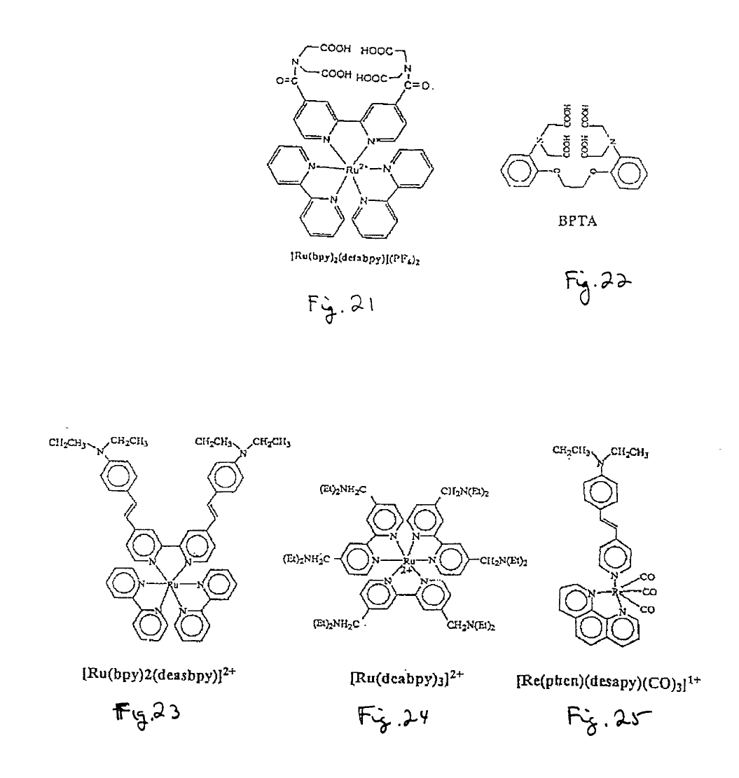

To use [Ru(deabpy)(bpy)₂]²⁺as a pH sensor we measured its pH-dependent phase and modulation, with a light modulation frequency of 700 kHz, FIGS. 8 and 9, respectively. As the pH is increased, the phase angles increased from 45 to 57 degrees, and the modulation decreases from 0.69 to 0.52. Similar data were obtained using the blue LED excitation source at 823 kHz (FIGS. 19 and 20). Conveniently, these changes occur over the pH range from 6 to 8. With present instrumentation one can expect the phase angles and modulation to be accurate to 0.1 degrees and 0.005 in modulation. Hence, the pH can be measured to about one part in 50, or ± 0.04 from pH 6 to 8. Such resolution is acceptable by medical standards [see, Continuous Intravascular and On-Demand Extravascular Arterial Blood Gas Monitoring. Mahutte, C. K.], however one can expect improved phase and modulation occurring with dedicated instrumentation and/or the use of multiple light modulation frequencies. This capability should find immediate applications for non-invasive pH sensing in tissue culture vessels, analogous to that recently reported for oxygen sensing [see, Non-Invasive Oxygen Measurements and Mass Transfer Limitations in Tissue Culture Flasks (1996). Randers-Eichhorn, D. L., R. Bartlett, D. Frey and G. Rao. Biotechnol. Bioeng., 51:466-478].

Discussion

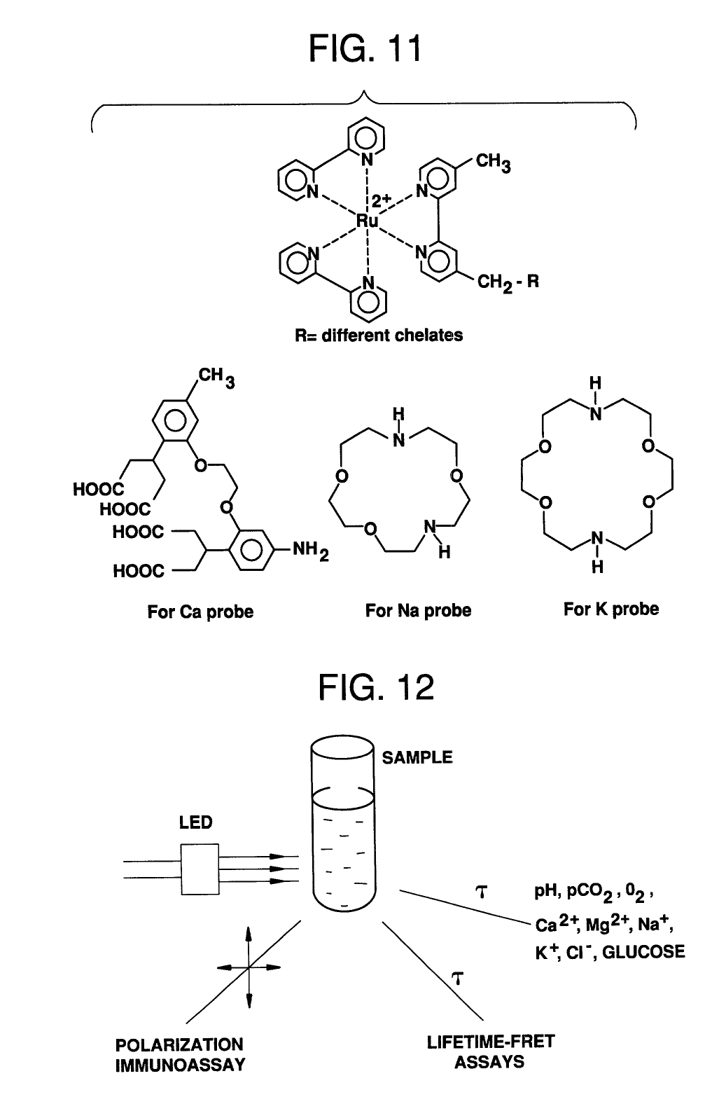

The MLC probe described is sensitive to pH, but a variety of other ions are of medical interest. However, the invention is applicable to metal-ligand probes for a wide variety of analytes. For instance, the lifetimes of ns probes with ion-chelating groups display changes in lifetime upon chelation. Such ns probes include Ca²⁺, Mg²⁺, Na²⁺and K⁺. Coupling of the appropriate chelating groups, such as BAPTA or an aza-crown ether, to a metal-ligand complex should result in metal-ligand probes which display ion-sensitive lifetimes. The structures of such potential probes are shown in FIG. 11. It is understood that this invention includes other luminescent metal-ligand complexes which include metals such as Re, Os, or Rh. Metal-ligand complexes can be used in immunoassays based on polarization or lifetimes modified by resonance energy transfer. See, e.g., Calcium Concentration Imaging Using Fluorescence Lifetimes and Long-wavelength Probes (1992). Lakowicz, J. R., H. Szmacinski and M. L. Johnson. J. Fluoresc. 2(l):47-62; Lifetime-based sensing of sodium (1996). Szmacinski, H. and J. R. Lakowicz. submitted for publication; Fluorescence Lifetime-Based Sensing and Imaging (1995). Szmacinski, H. and J. R. Lakowicz. Sensors and Actuators B, 29:16-24; Fluorescence Energy Transfer Immunoassay Based on a Long-Lifetime Luminescent Metal-Ligand Complex (1995). Youn, H. J., E. Terpetschnig, H. Szmacinski and J. R. Lakowicz. Analy. Biochemistry, 232:24-30; Fibre-Optic Oxygen Sensor with the Fluorescence Decay Time as the Information Carrier (1988). M. E. Lippitsch and O. S. Wolfbeis.

Long-lifetime cation probes open-up many applications with simple instrumentation. Because of the long decay time, the light modulation frequencies can be near 1 MHZ or lower. Hence, the light source can be a amplitude-modulated light emitting diode (LED). If necessary, signal detection can be performed simultaneously with electronic off-gating of the detector to suppress the ns components due to autofluorescence from the samples. Such probes and simple instrumentation may allow sensing in blood serum or whole blood, as shown in FIG. 12. Hence, the development of metal-ligand complexes can enable simple instrumentation for point-of-care clinical chemistry.

TABLE I
Single Decay Time Analysis of Ru(bpy)₂(deabpy)

| pH | τ(ns) | χ_{R}² |
|---|---|---|
| 2.40 | 236 | 5.22 (4.74)^{a} |
| 5.89 | 252 | 3.51 (3.19) |
| 6.91 | 262 | 2.91 (1.82) |
| 7.45 | 284 | 6.24 (3.69) |
| 8.02 | 327 | 3.13 (3.18) |
| 13.5 | 392 | 2.77 — |

^{a}The values in parenthesis are for the double exponential fit.

TABLE II
Global pH-Dependent Intensity Decay Analysis
of [Ru(deabpy) (bpy)₂]²⁺

| pH | τᵢ (ns) | τ₂ (ns) | α₁ | α₂ | χ_{R}² |
|---|---|---|---|---|---|
| 2.4 | 235 | 380 | 0.964 | 0.036 | |
| 5.8 | 235 | 380 | 0.893 | 0.107 | |
| 6.91 | 235 | 380 | 0.828 | 0.172 | 4.66^{a} |
| 7.45 | 235 | 380 | 0.687 | 0.313 | |
| 8.02 | 235 | 380 | 0.380 | 0.620 | |
| 13.5 | 235 | 380 | 0 | 1.0 | |

^{a}For the global single decay time analysis the χ_{R}² value was 124, with a mean decay of 294 ns.

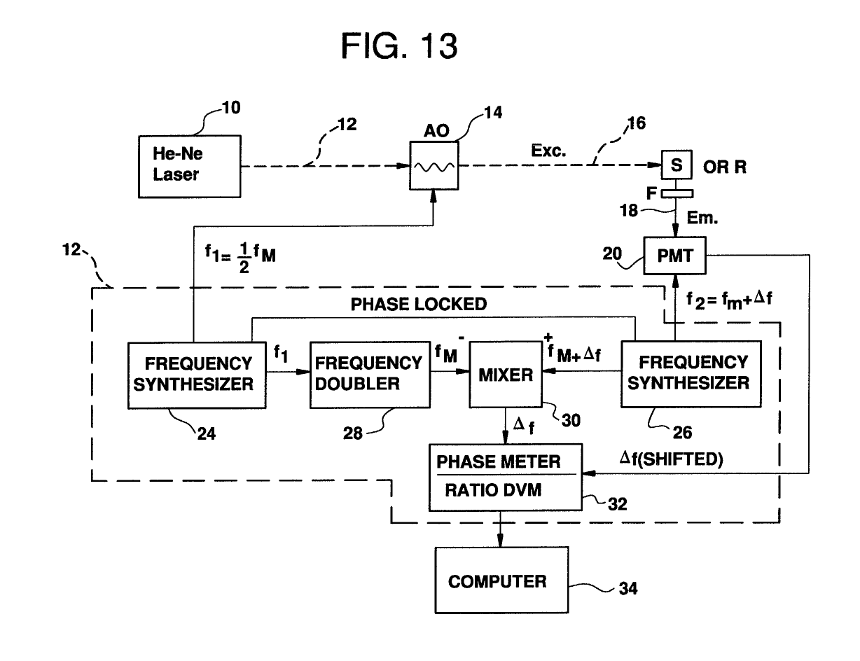

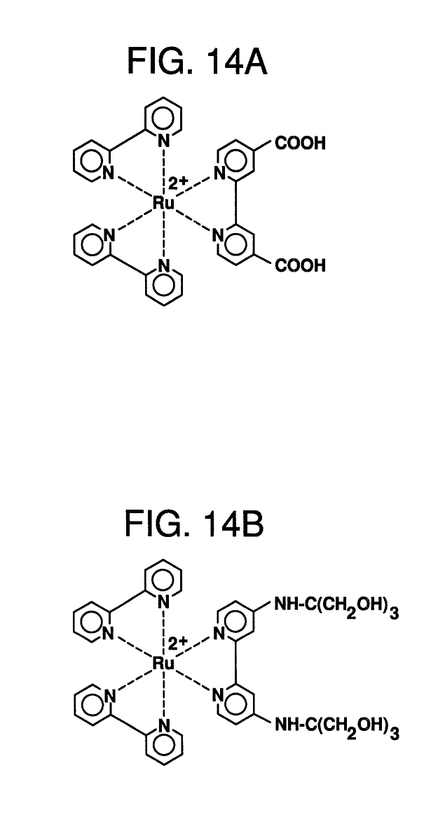

One embodiment of instrumentation for use with the method of the invention is schematically shown in FIG. 13. However, any suitable instrumentation can be used, reference being made to instrumentation disclosed in U.S. Pat. No. 4,937,457 to Mitchell, and those disclosed in Lakowicz, “A Review of Photon-Counting and Phase-Modulation Measurements of Fluorescence Decay Kinetics”, Applications of Fluorescence in the Biomedical Sciences, pp. 29-67 (1986), the contents of which are incorporated herein by reference.

As shown in FIG. 13, radiation source 10, emits excitation beam 12 which is modulated by acoustooptic modulator 14 at a frequency f1 to create sinusoidally-modulated excitation beam 16. It is to be understood that modulator 14 need not be an acoustooptic modulator, but that any suitable modulator may be used, such as an electrooptic modulator. Moreover, the modulation need not be sinusoidal, but of any desired shape. Also, the modulator need not be external, but instead the light source may be intrinsically modulated.

Sinusoidally-modulated excitation beam 16 irradiates sample S, which contains the analyte to be measured and the appropriate probe, with both bound and unbound species of the probe being contained within the samples. The irradiated sample emits emitted beam 18 which is detected at photo multiplier tube 20. Emitted beam 18 is amplitude modulated at the same frequency as the excitation but it is phase shifted and demodulated with respect to the excitation. It may be desirable to filter emitted beam 20 with optical filter F in order to change the effective sensitivity range of the detector, as explained above.

Cross-correlation circuit 22 includes first frequency synthesizer 24 which generates frequency f1, equal to one-half of a modulation frequency fM to drive acoustooptic modulator 14, and the PMT dynode chain. Cross-correlation circuit 22 also includes second frequency synthesizer 26 which generates a frequency f2 equal to the modulation frequency fM plus a cross-correlation frequency Δf to drive photo multiplier tube 20. First frequency synthesizer 24 is coupled to frequency doubler 28, which directs a signal having a frequency equal to the modulation frequency fM to mixer 30. Second frequency synthesizer 26 also directs a signal having frequency f2 equal to the modulation frequency fM plus the cross-correlation frequency Δf to mixer 30. Mixer 30 produces an output signal having a frequency equal to Δf, the difference between fM and f2.

Mixer 30 and photo multiplier tube 20 are each connected to phase meter/digital voltmeter 32. Phase meter/digital voltmeter 32 compares the output signal having a frequency Δf received from mixer 30 and the signal having a frequency Δf (shifted) received from photo multiplier tube 20 to calculate the phase shift θ, and the demodulation factor m which is stored in computer 34.

Since many modifications, variations and changes in detail may be made to the described embodiments, it is intended that all matter in the foregoing description and shown in the accompanying drawings be interpreted as illustrative and not in a limiting sense.

1. A method of measuring an analyte in a physiological sample, comprising the steps of:
contacting a metal-ligand complex probe with said physiological sample containing analyte, wherein the probe is bound to analyte in the sample to form an analyte-bound probe species, wherein bound and unbound species of said probe exist in said sample at a physiological pH, at least one of said bound and unbound species is fluorescent, each of said bound and unbound species being optically distinguishable;
exciting the sample containing the bound and unbound species with radiation, so as to produce a resulting emission from at least one of the bound and unbound species;
detecting the resulting emission over time so as to provide an optical measurement of the emission over time; and
determining concentration of the analyte in the sample utilizing a time-resolved calculation of the optical measurement of the emission.

2. The method of claim 1 wherein said analyte is pH, CO₂, sodium ion, potassium ion, calcium ion or magnesium ion.

3. The method of claim 1 wherein said analyte is pH or CO₂.

4. The method of claim 1 wherein the concentration of said analyte in the sample is determined by calculating apparent luminescence lifetime of said emission.

5. The method of claim 4 wherein said lifetime is calculated using phase-modulation fluorometry or time-resolved fluorometry.

6. The method of claim 1 wherein said probe comprises [Ru(deabpy) (bpy)₂]²⁺or [Ru(deabpy) (bpy)₂] (PF₆)₂.

7. The method of claim 1 wherein said probe comprises [Ru(deabpy)(bpy)₂]²⁺, [Ru(deabpy) (bpy)₂] (PF₆)_{2,} [Ru(bpy)₂ (detabpy)] (PF₆)₂, BPTA, [Ru(bpy)₂ (deasbpy)]²⁺, [Ru(dcabpy)₃ ]²⁺, or [Re(phen)(desapy)(CO)₃ ]¹⁺.

8. The method of claim 1 wherein said probe is a transition metal-ligand complex probe.

9. The method of claim 8 wherein said probe includes ruthenium, osmium, rhenium, or rhodium.

10. A method of measuring an analyte in a physiological sample, said analyte being selected from the group consisting of pH, CO₂, sodium ion, potassium ion, calcium ion and magnesium ion, the method comprising the steps of:
contacting a metal-ligand complex probe with said physiological sample containing said analyte at physiological pH, wherein photoluminescence of the probe is affected by said analyte;
exciting the sample with radiation so as to produce a resulting emission;
detecting the resulting emission over time so as to provide an optical measurement of the emission over time; and
determining concentration of said analyte in the sample utilizing a time-resolved calculation of the optical measurement of the emission.

11. The method of claim 10 wherein the concentration of said analyte in the sample is determined by calculating apparent luminescence lifetime of said emission.

12. The method of claim 11 wherein said lifetime is calculated using phase-modulation fluorometry or time-resolved fluorometry.

13. The method of claim 10 wherein said probe comprises [Ru(deabpy) (bpy)₂]²⁺or [Ru(deabpy) (bpy)₂] (PF₆)₂.

14. The method of claim 10 wherein said probe comprises [Ru(deabpy) (bpy)₂]²⁺, [Ru(deabpy) (bpy)₂] (PF₆)₂, [Ru(bpy)₂ (detabpy)] (PF₆)₂, BPTA, [Ru(bpy)₂ (deasbpy)]²⁺, [Ru(dcabpy)₃]²⁺, or [Re(phen) (desapy) (CO)₃ ]¹⁺.

15. The method of claim 10 wherein said probe is a transition metal-ligand complex probe.

16. The method of claim 15 wherein said probe includes ruthenium, osmium, rhenium, or rhodium.

17. The method claim 1, wherein the bound and unbound species have a difference in phase angle of at least about 10°, and a difference in modulation factor of at least about 10%.

18. The method claim 10, wherein the bound and unbound species have a difference in phase angle of at least about 10°, and a difference in modulation factor of at least about 10%.

19. The method of claim 1, wherein the bound and unbound species have a difference in phase angle of about 10-60°, and a difference in modulation factor of about 10-87%.

20. The method of claim 10, wherein the bound and unbound species have a difference in phase angle of about 10-60°, and a difference in modulation factor of about 10-87%.

21. A method of measuring an analyte in a physiological sample, comprising the steps of:
contacting a metal-ligand complex probe selecting from the group consisting of [Ru(deabpy) (bpy)₂]²⁺and [Ru(deabpy) (bpy)₂] (PF₆)₂ with said physiological sample containing analyte, wherein the probe is bound to analyte in the sample to form an analyte-bound probe species, wherein bound and unbound species of said probe exist in said sample at a physiological pH, at least one of said bound and unbound species being optically distinguishable;
exciting the sample containing the bound and unbound species with radiation, so as to produce a resulting emission from at least one of said bound and unbound species is fluorescent, each of said bound and unbound species being optically distinguishable;
exciting the sample containing the bound and unbound species with radiation, so as to produce a resulting emission from at least one of the bound and unbound species;
detecting the resulting emission so as to provide an optical measurement of the emission; and
determining the concentration of the analyte in the sample utilizing the optical measurement of the emission.

22. A probe for measuring an analyte in a physiological sample in accordance with the method of claim 1, comprising [Ru(deabpy) (bpy)₂]²⁺or [Ru(deabpy) (bpy)₂] (PF₆)₂.

23. A probe for measuring an analyte in a physiological sample in accordance with the method of claim 1, comprising [Ru(deabpy) (bpy)₂]²⁺, [Ru(deabpy) (bpy)₂] (PF₆)₂, [Ru(bpy)₂ (detabpy)] (PF₆)₂, BPTA, [Ru(bpy)₂ (deasbpy)]²⁺, [Ru(dcabpy)₃]²⁺, [Re(phen) (desapy) (CO)₃ ]¹⁺.
